(19) United States
(12) Patent Application Publication
(10) Pub. No.: US 2026/0170427 A1
(43) Pub. Date: Jun. 18, 2026

(54) DISTRIBUTED NETWORK DATA INSIGHTS

(71) Applicant: Wells Fargo Bank, N.A., San Francisco, CA (US)

(72) Inventors: Lokesh Anand, Phoenix, AZ (US); Devendra N. Shukla, Phoenix, AZ (US); Santhosh Kumar Madhavan Pillai, Matthews, NC (US); Haritha Vasantala, Hyderabad (IN); Inna Khachaturova, Minneapolis, MN (US); Vignesh Anand Sagadevan, Fort Mill, SC (US); S. Hargurjit Malhi, Cave Creek, AZ (US)

(21) Appl. No.: 18/984,417

(22) Filed: Dec. 17, 2024

(51) Int. Cl. G06Q 10/0631

(52) U.S. Cl. CPC G06Q 10/06313

(57) ABSTRACT

A computing system is configured to obtain usage data indicative of resource usage within a distributed network by a plurality of users of the distributed network. The computing system is further configured to correlate the usage data for each user of the plurality of users with an organizational unit of a plurality of organizational units of an organization associated with the distributed network and compute metrics for each organizational unit of the plurality of organizational units. The computing system is further configured to generate actionable insights based on the metrics and generate instructions based on actionable insights for computing devices associated with the at least one organizational unit, where the instructions are configured to cause the computing devices to perform an action. The computing system is further configured to send the one or more instructions to the computing devices.

### TECHNICAL FIELD

This disclosure relates to computer software applications and systems, in particular, computer systems that generate insights based on data of a distributed network.

### BACKGROUND

With the development of host environment technology, such as cloud hosting environments, organizations may provide multiple data platforms for users. For instance, organizations may leverage platforms that are provided by both public cloud providers and on-premises systems. Organizations may incur various costs with providing and using such platforms, such as costs for compute and memory usage.

### SUMMARY

In general, this disclosure describes a computing system configured to provide a unified control plane across multiple data platforms within a distributed network of an organization. The unified control plan provides monitoring of resource usage on a per-user level and a per-organizational unit level across the data platforms. The unified control plan also provides insights based on the resource usage with respect to different insight categories, such as cost, capacity, access, and operations categories. The computing system interacts with other computing devices within the organization to instruct the other computing devices to perform actions based on the insights.

A distributed network of an organization may include a plurality of services and systems across multiple data platforms, such as public cloud services possibly from different cloud providers, private cloud services, and/or on-premises data platforms. For instance, the distributed network may include dozens of platforms and tens of thousands of users. Monitoring operational health and performance for workloads across such a distributed network may be challenging due to the complexity of how workloads are shared across data platforms and the disparate and/or inconsistent ways that data metrics are made available by each of the data platforms. The techniques described in this disclosure provide a unified control plane in which data metrics are made available in consistent ways across all platforms to generate actionable insights based on the metrics and to generate instructions for other devices to perform actions based on those actionable insights.

In accordance with the disclosed techniques, the computing system is configured to obtain usage data indicative of resource usage within a distributed network by a plurality of users, correlate the usage data for each user with an organizational unit of the organization, compute one or more metrics corresponding to different insight categories based on the correlated usage data, and generate actionable insights based on the metrics for the organizational unit. The computing system may obtain the usage data from a variety of data platforms within the distributed network, such as on-premises systems, public clouds, enterprise clouds (e.g., private clouds), and other sources of information. The computing system obtains the usage data on a per-user level where the resource usage is associated with a user identifier that is associated with a particular organizational unit of the organization. The computing system then correlates the usage data for each individual user with a respective organizational unit of a plurality of organizational units of the organization. The computing system computes the metrics based on the correlated usage data for different insight categories, such as capacity, cost, access, and operations. The computing system may generate actionable insights based on the metrics for at least one organizational unit within the organization according to the insight categories, and generate and send instructions for computing devices within the organization to perform actions that are based on the actionable insights.

In one example, this disclosure is directed to a computing device that includes a memory and one or more processors in communication with the memory and configured to obtain, from a plurality of platforms within a distributed network, usage data indicative of resource usage within the distributed network by a plurality of users of the distributed network; correlate the usage data for each user of the plurality of users with an organizational unit of a plurality of organizational units of an organization associated with the distributed network; compute, based on the correlated usage data, one or more metrics for each organizational unit of the plurality of organizational units; generate one or more actionable insights based on the one or more metrics for at least one organizational unit of the plurality of organizational units; generate one or more instructions based on the one or more actionable insights for one or more computing devices associated with the at least one organizational unit, wherein the instructions are configured to cause the one or more computing devices to perform an action; and send the one or more instructions to the one or more computing devices associated with the at least one organizational unit to cause the one or more computing devices to perform the action..

In another example, this disclosure is directed to a method that includes obtaining, by a computing system and from a plurality of platforms within a distributed network, usage data indicative of resource usage within the distributed network by a plurality of users of the distributed network; correlating, by the computing system, the usage data for each user of the plurality of users with an organizational unit of a plurality of organizational units of an organization associated with the distributed network; computing, by the computing system and based on the correlated usage data, one or more metrics for each organizational unit of the plurality of organizational units; generating, by the computing system, one or more actionable insights based on the one or more metrics for at least one organizational unit of the plurality of organizational units; generating, by the computing system, one or more instructions based on the one or more actionable insights for one or more computing devices associated with the at least one organizational unit, wherein the instructions are configured to cause the one or more computing devices to perform an action; and sending, by the computing system, the one or more instructions to the one or more computing devices associated with the at least one organizational unit to cause the one or more computing devices to perform the action.

In yet another example, this disclosure is directed to non-transitory computer readable storage media storing instructions that, when executed, cause one or more processors of a computing system to obtain, from a plurality of platforms within a distributed network, usage data indicative of resource usage within the distributed network by a plurality of users of the distributed network; correlate the usage data for each user of the plurality of users with an organizational unit of a plurality of organizational units of an organization associated with the distributed network; compute, based on the correlated usage data, one or more metrics for each organizational unit of the plurality of organizational units; generate one or more actionable insights based on the one or more metrics for at least one organizational unit of the plurality of organizational units; generate one or more instructions based on the one or more actionable insights for one or more computing devices associated with the at least one organizational unit, wherein the instructions are configured to cause the one or more computing devices to perform an action; and send the one or more instructions to the one or more computing devices associated with the at least one organizational unit to cause the one or more computing devices to perform the action.

### BRIEF DESCRIPTION OF DRAWINGS

FIG. 1 is a block diagram of an example distributed network including a computing system configured to provide a unified control plane across data platforms, in accordance with one or more aspects of the present disclosure.

FIG. 2 is a conceptual diagram illustrating an example operation of a computing system configured to provide a unified control plane across data platforms, in accordance with one or more aspects of this disclosure.

FIG. 3 is a block diagram illustrating an example computing system, in accordance with one or more aspects of this disclosure.

FIG. 4 illustrates an example user interface for a unified control plane, in accordance with one or more aspects of this disclosure.

FIG. 5 illustrates an example user interface for a capacity category of a unified control plane, in accordance with one or more aspects of this disclosure.

FIG. 6 illustrates an example user interface for a cost category of a unified control plane, in accordance with one or more aspects of this disclosure.

FIG. 7 illustrates an example user interface for an access category of a unified control plane, in accordance with one or more aspects of this disclosure.

FIG. 8 illustrates an example user interface for an operations category of a unified control plane, in accordance with one or more aspects of this disclosure.

FIG. 9 is a flow chart illustrating an example operation of providing a unified control plane across data platforms, in accordance with one or more aspects of this disclosure.

### DETAILED DESCRIPTION

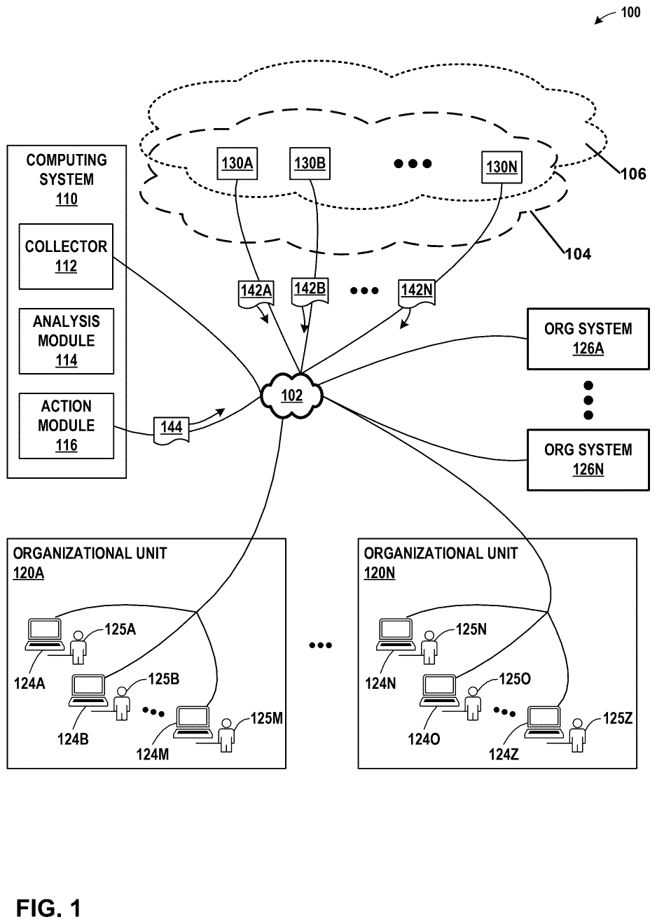

FIG. 1 is a block diagram of an example distributed network 100 including a computing system 110 configured to provide a unified control plane across data platforms 130A-130N, in accordance with one or aspects of the present disclosure. In FIG. 1, distributed network 100 includes network 102, public cloud 104, enterprise cloud 106, computing system 110, organizational units 120A-120N (hereinafter “organizational units 120”), and organization (“org”) systems 126A-126N (hereinafter “org systems 126”).

Distributed network 100 may be a distributed network of an organization, such as a financial institution. Distributed network 100 may include one or more networks, clouds, computing systems, and/or computing devices. For example, distributed network 100 may include a combination of on-premises systems of the organization, Software as a Service (SaaS) platforms provided by public or private cloud computing systems, other platforms, and user devices. The systems and devices of distributed network 100 may be interconnected by one or more networks that include network 102.

Network 102 may be a network that includes and connects one or more other networks, such as the Internet, one or more private networks, wide area networks (WANs), metropolitan area networks (MANs), local area networks (LANs), and/or other types of networks. Network 102 may interconnect computing systems, devices, and platforms of distributed network 100. For example, network 102 may connect platforms provided by public cloud 104 to computing system 110.

Public cloud 104 and enterprise cloud 106 may be cloud computing systems that are public or private to the organization of distributed network 100, respectively. Public cloud 104 may include one or more cloud computing systems provided by an organization other than the organization of distributed network 100, such as a cloud computing system provided by an external vendor and that executes one or more platforms used by employees of the organization. Enterprise cloud 106 may be private cloud computing system provided by the organization of distributed network 100, such as a cloud computing system provided by on-premises computing systems of the organization.

Public cloud 104 and/or enterprise cloud 106 may provide platforms 130A-130N (hereinafter “platforms 130”). Platforms 130 may include storage platforms, data analysis platforms, customer data platforms, software development and testing platforms, project management platforms, and/or other types of platforms. Platforms 130 may provide services, such as public cloud services possibly from different cloud providers, private cloud services, and/or on-premises data platforms in addition to data analytics, software development, and/or workload processing used by users 125 of distributed network 100. For example, platform 130B may provide a data visualization service for users of distributed network 100. Platforms 130 may be accessible by user computing devices, such as user computing devices 124 of organizational units 120, via network 102.

Org systems 126 may be computing systems of the organization of distributed network 100 and may include one or more of servers, mainframes, virtualized computing environments, and other types of computing systems. Org systems 126 may provide one or more types of functionalities for the organization that include generating tickets, generating invoices, modifying user access entitlements, modifying a configuration of distributed network 100 (e.g., modifying allocations of network resources of public cloud 104 and/or enterprise cloud 106), and other types of functionalities.

Distributed network 100 may include one or more organizational units, such as organizational units 120, that are logical groupings of devices of the organization. Organizational units 120 may be logical groupings that are business units of the organization divided based on the products offered by the corresponding business unit, such as wealth management, lending, data analytics, financial planning, financial analysis, accounting, etc. In addition, organizational units 120 may be organized along one or more lines that include locations of users, roles of the users, product offerings, business categories, etc. For example, organizational unit 120A may be an organizational unit of the organization that provides financial planning and organizational unit 120B may be an organizational unit that offers wealth management. Organizational units 120 may each include a plurality of users that are organized into organizational units 120 by corresponding user identifiers and a plurality of user devices associated with the users.

In some examples, organizational units 120 include a project defined by another computing system, such as computing system 110. Organizational units 120 may include projects that have defined user roles and access entitlements as well as bound to one or more environments within distributed network 100. In an example, computing system 110 receives a request for a project that includes an application ID, requested environments, and/or other information. Computing system 110 generates the project as an organizational unit in the requested environments and as including user roles and access entitlements.

Organizational units 120 may each include at least one user device associated with a user. In the example of FIG. 1, organizational unit 120A includes user devices 124A-124M and users 125A-125M, and organizational unit 120N includes user devices 124N-124Z and users 125N-125Z. User devices 124A-124M and 124N-124Z may be collectively referred to as “user devices 124” throughout, and may include one or more types of computing devices, such as laptops, desktops, tablet computers, smartphones, virtualized computing environments, thin clients, and/or other types of computing devices. Users 125A-125M and 125N-125Z may be referred to as “users 125” throughout and may include human users who use user devices 124 to interact with platforms 130 and other systems within distributed network 100. In other examples, users 125 may include non-human system users, which may include applications, software agents or bots, or other software modules configured to automatically interact with platforms 130 as part of a process workflow and without human direction. In addition, the individual users of user 125 (e.g., both the human and non-human users) may be uniquely associated with an identifier (e.g., alphanumeric strings). In an example, user 125B logs into user device 124B. User 125B uses user device 124B to connect to and interact with platform 130B via network 102. Platform 130B records the interaction with user device 124B and associates the interaction with an identifier of user 125B.

Users 125 may use user devices 124 to interact with platforms 130 as part of various workflows and processes of the organization. In an example, user 125M uses user device 124M to send a request for customer information to platform 130N. Platform 130N receives the request and sends the requested customer data to user device 124M.

The organization of distributed network 100 may find it challenging to manage the usage and user experience of using platforms 130 due to the complexity of distributed network 100. For example, distributed network 100 may contain dozens of platforms 130 that provide functionality for tens of thousands of users. In addition, information regarding the use of network resources by users 125 may be reported by platforms 130 in a variety of different formats and processed by independent systems that make it challenging to obtain a high level overview of distributed network 100. For example, platform 130B may report usage data in one format to a first set of administrators, while platform 130A may report usage data in a different format to a second set of administrators.

According to the disclosed techniques, computing system 110 is configured to provide a unified control plane to monitor and manage the usage of platforms 130 within distributed network 100. The disclosed unified control plane may reduce the workload of administrators in managing the operation and costs of platforms 130 within distributed network 100. For example, the unified control plane may determine actionable insights based on the monitored usage data across platforms 130 and automatically instruct other computing devices, such as org systems 126, to perform actions based on the determined actionable insights, such as generating invoices for network usage associated with at least one of organizational units 120 or generating tickets to modify allocation of network resources, modify configuration of at least one platform, and/or certify access entitlements for at least one of organizational units 120. In such a way, the unified control plane may enable the automation of managing the usage and user experience of using platforms 130.

In order to provide the unified control plane, computing system 110 may obtain usage data 142A-142N (hereinafter “usage data 142”) from platforms 130 and process usage data 142 to generate actionable insights according to one or more categories. Computing system 110 may generate instructions for computing devices within distributed network 100, such as org systems 126, to perform actions based on the actionable insights.

Computing system 110 may be a computing system, such as a server, virtualized computing system, or other type of computing system and connected via network 102 to other computing devices and systems of distributed network 100. For example, computing system 110 may be a computing system executed by a cloud computing system, such as enterprise cloud 106. Computing system 110 may executed by an on-premises system and/or by an offsite system, such as enterprise cloud 106. In addition, computing system 110 may include software components that provide various functionality for computing system 110.

Computing system 110 includes collector 112 which may be a software component of computing system 110, such as a module, plugin, process, executable, and/or other type of software component. Collector 112 may obtain information that includes usage data 142 from platforms 130 for computing system 110 in one or more ways, e.g., “pull” usage data 142 from one or more of platforms 130 (e.g., requesting or polling) or by causing platforms 130 to “push” usage data 142 to collector 112 (e.g., periodic or continuous reporting).

Usage data 142 may be information generated by platforms 130 in one or more formats and sent to computing system 110. Usage data 142 may include information regarding consumption of network resources, user entitlements, availability of network resources, auto-generated reports, and/or other information in one or more formats. For example, usage data 142A may be a spreadsheet of user entitlements and user identifiers and usage data 142B may be network data reported by platform 130B.

In some examples, collector 112 may obtain usage data 142 from one or more clouds, such as public cloud 104 and/or enterprise cloud 106. Collector 112 may obtain usage data 142 from clouds via reporting systems of the clouds. For example, collector 112 may obtain a portion of usage data 142 from a reporting system provided by public cloud 104. Collector 112 may provide usage data 142 to one or more components of computing system 110 for processing and analysis, such as analysis module 114. Collector 112 may obtain usage data 142 on a per-user level, such as service calls associated with individual user identifiers of users 125, compute calls associated with individual user identifiers of users 125, other user interactions with platforms 130 tracked by individual user identifiers, etc..

Computing system 110 includes analysis module 114, which may be a software component of computing system 110 such as a module, plugin, process, executable, and/or other type of software component. Analysis module 114 may process usage data 142 obtained from platforms 130 to correlate usage data 142 with users of each organizational unit of organizational units 120, such as the resource usage by each user of organizational units 120. In an example, analysis module 114 obtains usage data 142 that includes information regarding the usage of network resources by users 124 and processes usage data 142 to correlate the usage of network resources by users 125A-125M with organizational unit 120A (e.g., correlate the usage data of users having user identifiers that are associated with organizational unit 120A) and correlate the usage of network resources by users 125N-125Z with organizational unit 120N (e.g., correlate the usage data of users having user identifiers that are associated with organizational unit 120N). Analysis module 114 may correlate usage data 142 with individual users and associated organizational units to track types and amounts of resource usage by individual users and by organizational unit. For example, analysis module 114 may correlate usage data 142 to individual organizational units of organizational units 120 to determine that organizational unit 120N regularly uses comparatively more compute resources of enterprise cloud 106 than organizational unit 120A.

Analysis module 114 may compute metrics for each of organizational units 120 based on usage data 142. Analysis module 114 may compute metrics that are indicative of capacity (e.g., available vs used capacity) of network resources (e.g., storage, processing/compute, memory, etc.), cost of resource usage (e.g., total cost, usage, allocations of resources, etc.), user access (e.g., users and assigned roles, user entitlements, etc.), operational performance (e.g., service level agreement (SLA) monitoring, monitoring of jobs performed by platforms 130, volumes of data ingress/egress from platforms 130, health of platforms 130, etc.), and other metrics. Analysis module 114 may compute the metrics by applying one or more filters to usage data 142, applying heuristics to usage data 142, and/or one or more models to usage data 142. For example, analysis module 114 may compute metrics relating to financial costs of resource usage by determining quantity and/or duration of resource usage by one or more of users 125 associated with organizational unit 120A and corresponding costs per unit of quantity or unit of time. As part of computing the metrics, analysis module 114 may aggregate usage data 142 that corresponds to resource usage by users 125 within each organizational unit of organizational units 120. In an example, analysis module 114 correlates the usage data to users 125A-125M of organizational unit 120A to determine the resource usage by each user of organizational unit 120A among other metrics. Analysis module 114 aggregates the usage data of users 125A-125M to determine the resource usage of organizational unit 120A.

Analysis module 114 may generate one or more actionable insights that are insights into the performance and usage of platforms 130 based on the metrics for one or more of organizational units 120 and that may be used as a basis for further action. Analysis module 114 may use one or more techniques to generate actionable insights that include applying one or more ML models, applying rules-based models, applying heuristics, and/or other techniques. In an example, analysis module 114 computes metrics regarding available and used capacity of network storage resources allocated to organizational unit 120N, where the metrics are indicative of available network storage being below a predetermined threshold (e.g., less than 3% of network storage being unused and available). Analysis module 114 generates an actionable insight based on the metrics that the network storage capacity allocated to organizational unit 120N should be increased.

Analysis module 114 may generate actionable insights corresponding to one or more categories that include a cost category that is representative of financial costs related to resource usage within distributed network 100, a capacity category that is representative of capacity (e.g., available vs used) of network resources within distributed network 100, an access category that is representative of access entitlements to platforms 130 for each of users 125, and an operations category that is representative of operational performance of platforms 130. Analysis module 114 may generate actionable insights corresponding to a single category or to multiple categories. For example, analysis module 114 may compute metrics indicative of availability of compute resources allocated to organizational unit 120A to generate a first actionable insight related to organizational resource capacity for organizational unit 120A regularly dropping below a predetermined threshold. Analysis module 114 may provide an indication regarding the actionable insight to action module 116.

Computing system 110 includes action module 116 that may be a software component of computing system 110, such as a module, plugin, process, executable, and/or other type of software component. Action module 116 may generate data representative of user interfaces, such as graphical user interfaces (GUIs), that display information. Action module 116 may generate the GUIs as including dashboards displaying information regarding actionable insights and/or other information relevant to distributed network 100. For example, action module 116 may generate a GUI that includes a visualization of a total cost of network resources for a given quarter that is broken down by organizational units 120. Action module 116 may provide the GUIs to one or more computing devices or systems for display.

Action module 116 may generate instructions 144 for one or more other computing systems, such as org systems 126, that are based on actionable insights generated by analysis module 114 to cause org systems 126 to perform an action. Action module 116 may generate instructions 144 to cause org systems 126 to perform actions that include generating invoices, modifying user entitlements, modifying allocations of network resources, modifying configurations of platforms 130, and other actions. In an example, action module 116 receives an actionable insight from analysis module 114 that includes information regarding a cost of network resources used by users 125A-125M of organizational unit 120A for a most recent fiscal quarter. Action module 116 generates instructions 144 for the creation of an invoice for the cost of the network resources and provides instructions 144 to, e.g., org system 126N. Org system 126N generates and submits an invoice for the cost of the network resources to organizational unit 120A in response to receipt of instructions 144. Action module 116 may control operation of org systems 126 by sending control signals including instructions 144 and thereby causing org systems 126 to perform actions specified by instructions 144.

Instructions 144 may include one or more types of information, such as plain text, software code, and/or other information. Instructions 14 may be generated and configured by action module 116 to cause org systems 126 to perform one or more actions. In an example, action module 116 generates instructions 144 as including machine-language configured to cause one of org systems 126 to generate an invoice. The one of org systems 126 receives instructions 144 via network 102 and generates the invoice based on instructions 144.

In some examples, action module 116 generates instructions 144 to cause org systems 126 to generate an invoice for usage associated with one or more projects. Computing system 110 may use labels created for the project to associate network resource usage with the project and correct line of business. In an example, action module 116 instruction 144 as configured to cause org systems 126 create a billing record table using a price table and billing information. Org systems 126 may further process the billing record using a billing system of the organization to generate periodic invoices (e.g., monthly, daily, quarterly, annually, etc.) for a line of business associated with the project.

The techniques of this disclosure may provide one or more practical advantages. The use of computing system 110 may enable an administrator to understand the operational health and performance of workloads across multiple platforms hosted across public cloud systems and private cloud or on-premises systems of distributed network 100. Distributed network 100 may contain dozens of platforms 130 that provide functionality for tens of thousands of users and report usage by those users in a variety of different formats. As such, the actionable insights generated by computing system 110 may be extremely difficult if not impossible for a human to generate, particularly in a timely manner such that the insights reflect a current functionality of distributed network 100. For example, computing system 110 may enable the organization to determine costs associated with network resource usage across the multiple platforms by organizational units or lines of business and charge back the costs associated with the network resource usage to the corresponding organizational units or lines of business on demand or on a weekly or monthly basis. Computing system 110 may similarly enable the organization to gain insights into network resource usage for modification of resource allocation and/or platform configuration on a per-organizational unit level in order to solve real-time performance constraints and/or meet SLAs. Computing system 110 may also enable the organization to gain insights into network resource usage for certification of user entitlements on a per-user level or a per-organizational unit level in near real-time to avoid security gaps and/or impedance of necessary access by appropriate end users.

In addition, computing system 110 may control operation of other org systems 126 within distributed network 100 and cause the other org systems 126 to perform actions based on the actionable insights generated by computing system 110 without requiring interaction or instruction from administrators or other human users. The automation of instructions for the other org systems 126 to perform actions may reduce operational overhead and simplify management of distributed network 100. For example, instead of generating a notification or alert for an administrator or other human user to first read and then potentially act upon, which may include accessing multiple systems and using additional computational and bandwidth resources, computing system 110 may instruct one of org systems 126 to automatically perform the action, e.g., generate an invoice for the organizational unit, allocate additional resources to the organizational unit, or the like.

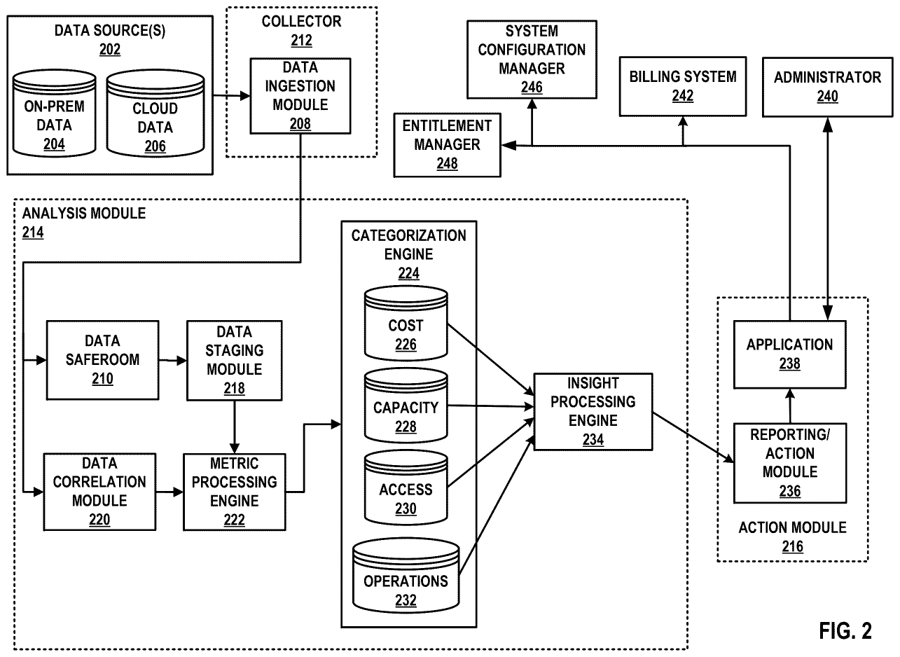

FIG. 2 is a conceptual diagram illustrating an example operation of a computing system configured to provide a unified control plane across data platforms, in accordance with one or more aspects of this disclosure. One or more devices or systems of FIG. 1, such as computing system 110, may perform any one or more of the steps of the example operation computing system illustrated in FIG. 2.

FIG. 2 includes data sources 202, which may be sources of data from one or more clouds or other data sources included in a distributed network, such as distributed network 100 as illustrated in FIG. 1. In the example of FIG. 2, data sources 202 include on-prem data 204 and cloud data 206. On-prem data 204 may be data that is stored on-site in one or more locations of the organization, such as organization data centers, offices, storage facilities, etc., as well as cloud computing systems provided by the organization. Cloud data 206 may be data that is generated and provided by public clouds or computing systems used by the organization. For example, cloud data 206 may include data generated by platforms, such as platforms 130 as illustrated in FIG. 1.

A collector, such as collector 212, obtains usage data from data sources 202 using data ingestion module 208. Collector 212 may be a software component of a computing system, such as computing system 110, that obtains usage data from one or more sources that include data sources 202 and may be similar to collector 112 as illustrated in FIG. 1. Collector 212 may use a software component, such as data ingestion module 208, to obtain on-prem data 204, cloud data 206, and/or other information from data sources 202. In an example, data ingestion module 208 obtains on-prem data by polling computing systems of the organization and obtains cloud data 206 via reporting systems provided by the public clouds. Data ingestion module 208 may extract usage data included in the data from data sources 202 on a per-user level. For example, data ingestion module 208 may extract usage data associated with individual identifiers from data sources 202. Collector 212 may provide the information obtained by data ingestion module 208 to one or more components, such as analysis module 214, for processing.

Analysis module 214 may be a software component of the analysis system that analyzes usage data obtained by collector 212 and may be similar to analysis module 114 as illustrated in FIG. 1. Analysis module 214 may process or otherwise analyze the data obtain by collector 212 to generate metrics and action insights. For example, analysis module 214 may correlate usage data to individual organizational units as part of processing the usage data.

As part of processing the obtained usage data, analysis module 214 may maintain a record of user entitlements and assigned roles in data saferoom 210. Data saferoom 210 may be a data repository, data store, and/or other type of data storage or structure that includes information regarding user roles and user entitlements and that is a secure data store. Analysis module 214 may store information regarding the user roles and user entitlements in data saferoom 210 to ensure the security and confidentiality of the user roles and user entitlements.

Analysis module 214 may pre-process the data stored in data saferoom 210 in preparation for further analysis using data staging module 218. Analysis module 214 may process the information regarding user roles and user entitlements into one or more formats for further processing by analysis module 214 and to reduce the amount of information needed from the secure storage of data saferoom 210. Analysis module 214 may pre-process the data regarding user roles and entitlements into user access data. In an example, analysis module 214 obtains information from data saferoom 214 regarding user entitlements for a particular subset of users and processes the information into a format used by analysis module 214 for later analysis.

As part of processing the data obtained by collector 212, analysis module 214 correlates the data to organizational units of the organization, such as organizational units 120 as illustrated in FIG. 1, using data correlation module 220. Data correlation module 220 may be a software component of analysis module 214 that correlates the data using one or more techniques that include correlating data associated with user identifiers with an organizational unit that includes the user, correlating usage of network resources with a particular organization, and/or other techniques. For example, data correlation module 214 may correlate usage of network resources across cloud computing systems associated with a user identifier to a particular organizational unit.

Analysis module 214 may use metrics processing engine 222 to compute metrics for each organizational unit of the organizational unit using the correlated usage data and the user access data. Metrics processing engine 222 may be a software component of analysis module 214 that computes metrics regarding one or more aspects of the usage of and interactions with platforms used by the organization, such as availability of network resources, usage of the network resources, costs associated with the network resources, user access to the network resources, and/or other metrics. Analysis module 214 may use metrics processing module 214 to compute metrics on a per-organizational basis. For example, metrics processing engine 222 may compute metrics for a particular organizational unit regarding usage of network resources by the organizational unit, availability of network resources, user entitlements of the users included in the organizational unit, and other metrics.

Analysis module 214 may use categorization engine 224 to compute and organize the metrics into one or more categories as part of categorization 224. Categorization engine 224 may be a software component of analysis module 214 that computes and organizes the metrics into the one or more categories that include a cost category 226 (illustrated as “COST 226”) representative of financial costs related to resource usage within distributed network 100, a capacity category 228 (illustrated as “CAPACITY 228”) representative of capacity of network resources within distributed network 100, an access category 230 (illustrated as “ACCESS 230”) representative of access entitlements to the platforms of distributed network 100, and an operations category 232 (illustrated as “OPERATIONS 232”) that is representative of operational performance of the platforms of distributed network 100. Categorization engine 224 may categorize the metrics into more than one of the categories. For example, categorization engine 224 may categorize metrics regarding usage of a platform into cost category 226 and capacity category 228.

Analysis module 214 may compute metrics for cost category 226 that are indicative of costs of resource usage by aggregating resource usage by each user of an organizational unit. Analysis module 214 may aggregate resource usage that includes storage usage associated with the user identifiers (e.g., usage of network storage or allocations of network storage within platforms 130), compute usage associated with the user identifiers (e.g., usage of cloud compute or other computing resources of platforms 130), and/or other types of resource usage (e.g., bandwidth) associated with platforms 130. For example, analysis module 214 may determine resource usage by user identifier for individual users of platforms 130 and aggregate the individual resource usage into the organizational resource usage for each organizational unit based on the user identifiers associated with each of the organizational units.

Analysis module 214 may compute metrics for capacity category 228 that indicative of availability of network resources by processing information regarding the consumption of network resources and the allocation of the network resources. Analysis module 14 may compare the amount of allocated network resources to the consumption of network resources to determine the availability of the network resources over a period of time to determine both trends regarding the availability of network resources and the availability of network at a given point in time. For example, analysis module 14 may process information regarding the consumption and allocation of network resources to determine daily availability of network resources for a period of several days.

Analysis module 214 may compute metrics for access category 230 that are indicative of user access to platforms 130 and/or functionality provided by platforms 130. Analysis module 214 may compute the metrics for access category by processing the information regarding user access entitlements to generate records regarding user access entitlements that are assigned to individual users (e.g., assigned to individual user identifiers that correspond to human users and non-human users). For example, analysis module 214 may compute the metrics for access category 230 by processing information regarding user access entitlements obtained from data sources 202 and associating user access entitlement with user identifiers for each organizational unit.

Analysis module 214 may compute metrics for operations category 232 that are indicative of operational performance of platforms 130. Analysis module 214 may compute metrics for operations category 232 that include metrics regarding service level agreements (SLAs), job performance monitoring (e.g., the performance of platforms 130 in completing jobs for users), ingress and egress of data (e.g., the amount of data flowing into, out of, and between platforms 130), and platform health (e.g., whether any of platforms 130 are in an error state). For example, analysis module 214 may compute metrics for operations category 232 regarding whether one or more platforms are meeting SLAs.

Analysis module 214 generates actionable insights that are insights into the performance and usage of platforms 130 based on the metrics categorized by categorization engine 224 for one or more organizational units of the organization using insight processing engine 234. Insight processing engine 234 may be a software component of analysis module 214 that generates actionable insights for one or more of the categories. For instance, analysis module 214 may generate actionable insights for cost category 226 and capacity category 228 for a given organizational unit.

Analysis module 214 may generate actionable insights corresponding to cost category 226 that include determining organizational financial costs representative of the financial costs of usage of network resources. Analysis module 214 may generate the organization financial costs by processing metrics regarding usage of network resources by organizational units and determining a financial cost associated with the usage of the network resources. For example, analysis module 214 may determine, for a given organizational unit, a financial cost of the network resources used by the organizational unit for a given period of time.

In some examples, analysis module 214 may generate actionable insights corresponding to cost category 226 that are forecasted organizational financial costs. Analysis module 214 may generate forecasted organizational financial costs that are representative of forecasted financial costs for usage of network resources. Analysis module 214 may generate the actionable insights that are forecasted organizational financial costs by determining one or more patterns of previous organizational financial costs and interpolating future (e.g., forecasted) organizational financial costs based on the patterns of previous organizational financial costs. Analysis module 214 may enable the organization of distributed network 100 to project planned workload costs using forecasted organizational financial costs that are based on historical information and expected organic growth.

Analysis module 214 may generate actionable insights corresponding to capacity category 228 by determining organizational resource capacity for organizational units based on the metrics corresponding to capacity category 228. Analysis module 214 may determine organizational resource capacity that is indicative of the availability of network resources for organizational units. For example, analysis module 214 may determine organizational resource availability as including an indication the availability of compute and storage resources for an organizational unit (e.g., the unused capacity of the compute and storage resources). As part of determining the actionable insights corresponding to capacity category 228, analysis module 214 may determine the availability of network resources as a percentage of allocated resources compared to resources utilization. In addition, analysis module 214 may enable the organization to determine cloud workload placements (e.g., public cloud, private cloud, on-prem, etc.) using cost and budget considerations. For example, analysis module 214 may enable an organization to make cloud workflow placement, service, design, and tooling decisions in view of cost and budget considerations for current, expanded, and future workflows.

Analysis module 214 may generate actionable insights corresponding to access category 230 by determining an organizational entitlement mapping for one or more of the organizational units. Analysis module 214 may determine an organizational entitlement mapping that is a mapping of user identifiers to assigned roles and current user access entitlements by comparing a role assigned to a user identifier and the current access entitlements assigned to that user identifier for each user identifier of an organizational unit. For example, analysis module 214 may determine an organizational entitlement mapping for an organizational unit that includes entries for each user identifier, corresponding role, user access entitlements associated with the corresponding role, and the currently assigned user access entitlements.

Analysis module 214 may generate actionable insights corresponding to operations category 232 by determining organizational performance of organizational units. Analysis module 214 may determine the organizational performance based on one or more metrics that include SLA status (e.g., whether SLAs being met), jobs monitoring (e.g., status of jobs, length of time to complete jobs, etc.), volume of data ingress/egress from platforms 130, among platform health (e.g., healthy or in error state) other metrics. Analysis module 214 may determine organizational performance that is indicative of various performance aspects of platforms 130, such as on-premises performance metrics, lists of users by line of business that includes indications of assigned role and activity status, platform performance, platform health, status of various data sets and lifespan of platforms 130.

Analysis module 214 provides indications of actionable insights to action module 216, which may be similar to action module 116 as illustrated in FIG. 1. Action module 216 generates instructions based on the actionable insights using reporting/action 236 module to cause computing systems, such as org systems 126 as illustrated in FIG. 1, to perform an action based on the actionable insights. Reporting/action module 236 may be a software component of action module 216 that manages reporting and generation of actions. For example, action module 216 may use reporting/action module 236 to generate instructions configured to cause org system 126A to generate an invoice for a line of business based on resource usage associated with the line of business. Action module 216 may generate instructions for one or more of the categories.

Action module 216 may generate instructions for cost category 226 based on actionable insights regarding organization financial costs. Action module 216 may generate instructions for cost category 226 that include instructions configured to cause a computing system, such as billing system 242, to generate invoices for organizational units based on the financial costs of resource usage by corresponding organizational units. Billing system 242 may be an organizational computing system that is configured to manage billing for the organization of distributed network 100. Action module 216 may generate the instructions to cause billing system 242 to generate an invoice and charge back the financial costs incurred through usage of network resources by the organizational unit. In some examples, action module 216 may generate instructions configured to cause application 238 and/or billing system 242 to generate a report of forecasted organizational financial costs for one or more organizational units.

Action module 216 may generate instructions for capacity category 228 based on the organizational resource capacity. Action module 216 may generate instructions for capacity category 228 that are configured to cause one or more of org systems 126 to modify allocations of network resources within distributed network 100, such allocations of data storage capacity, memory, compute resources, bandwidth, and/or other resources. In an example, action module 216 receives an actionable insight from analysis module 214 that a given organizational unit regularly uses nearly all the compute resources allocated to the organizational unit. Action module 216 generates instructions configured to cause system configuration manager 246, to increase the allocation of compute resources allocated to the organizational unit. In some examples, action module 216 may generate instructions to cause system configuration manager 246 to generate usage alerts when resource usage exceeds a given threshold (e.g., per-user, per-line of business, per-domain, per-project, etc.).

Action module 216 may generate instructions for access category 230 based on the organizational entitlement mapping. Action module 216 may generate instructions for access category 230 that are configured to cause one or more of org systems 126, such as entitlement manager 248, to certify access entitlements of at least one user having a user identifier associated an organizational unit based on the organizational entitlement mapping for the organizational unit. Entitlement manager 248 may be a computing system of org systems 126 that manages user access entitlements for distributed network 100. In an example, action module 216 receives an organizational entitlement mapping for a given organizational unit. Action module 216 generates instructions to cause entitlement manager 248 to certify the user access entitlements of the users included in the organizational unit by comparing assigned user access entitlements to user access entitlements associated with the roles assigned to each user.

In some examples, action module 216 identifies one or more incorrect access entitlements based on the actionable insights that correspond to access category 230. Action module 216 may identify the incorrect user access entitlements by comparing the access entitlements for a user to a corresponding role of the user, where the corresponding role includes a predetermined access entitlement for the user. Based on identifying the incorrect access entitlement, action module 216 generates instructions to remediate the incorrect user access entitlement and provides the instructions to entitlement manager 248.

In some examples, action module 216 may receive an indication of an incorrect user access entitlement for a user identifier from org systems 126. Org systems 126 (e.g., entitlement manager 248) and/or administrators (e.g., administrator 240) of distributed network 100 may determine whether currently assigned user access entitlements are incorrect and provide an indication to action module 216. Based on the indication, action module 216 generates second instructions that are configured to cause org systems 126 to modify the incorrect access entitlement (e.g., remediate the incorrect access entitlement). In an example, action module 216 receives an indication from computing system 126A that a given user has user access entitlements that grant access to a secure file repository and that those access entitlements are incorrectly assigned based on the role of the user. Action module 216 generates instructions to cause computing system 126A modify the user access entitlements associated with the user and disable access to the secure file repository.

Action module 216 may generate instructions for operations category 232 based on the organizational performance determined by analysis module 214. Action module 216 may generate the instructions as configured to cause org systems 126 to modify a configuration of one or more of platforms 130 in one or more ways, such as reconfiguring platforms 130, modifying data flows, ensuring SLA compliance, and/or one or more other ways. In an example, action module 216 generates instructions configured to cause system configuration manager 246 to modify data flows between platforms 130. Action module 216 may provide the instructions to application 238 and/or directly to org systems 126.

Action module 216 provides application 238, which may be a web application, server application, or other type of application that provides instructions and user interfaces to recipients within distributed network 100. In response to the generation of instructions by action module 216, application 238 determines a recipient computing system of org systems 126 and provides the instructions to the recipient computing system. In addition, application 238 may use the actionable insights generated in insight processing 234 and the instructions to generate user interfaces that visually display information regarding one or more of the categories. In an example, application 238 generates a user interface that includes visual indications indicative of whether platforms 130 are in healthy or alarm states.

Application 238 provides the user interfaces to one or more recipients that include administrator 240, which may be an administrator device (e.g., a computing device associated with an administrator) of distributed network 100. Application 238 may provide the user interfaces in one or more ways, such as via a web application accessible by a browser of administrator 240, a companion application executed by administrator 240, and/or other ways. In an example, application 238 generates a user interface that includes visual indications of costs associated with resource usage by a given organizational. Application 238 provides the user interface via a web portal to administrator 240 for administrator 240 to access via a browser.

Application 238 may receive input from administrator 240 via the provided user interface that is indicative of one or more types of interactions. Application 238 may receive input indicative of interactions that include selecting a different tab that corresponds to one of the categories, interacting with a visual element that associated with an actionable insight, and/or other interactions. Based on receiving the interaction, application 238 may provide instructions to org systems 126.

Application 238 provides instructions based on the actionable insights to recipient devices that include billing system 242, system configuration manager 246, entitlement manager 248, and/or other recipient devices. Billing system 242 and system configuration manager 246 may be computing systems of org systems 126 that perform actions in response to the receipt of instructions. For example, billing system 242 may generate invoice for organizational units to charge back usage of network resources in response to receiving instructions to perform the action of generating the invoice. In another example, system configuration manager 246 receives instructions to perform an action of modifying an allocation of compute resources for an organizational unit. System configuration manager 246 modifies the allocation of compute resources based on the instructions.

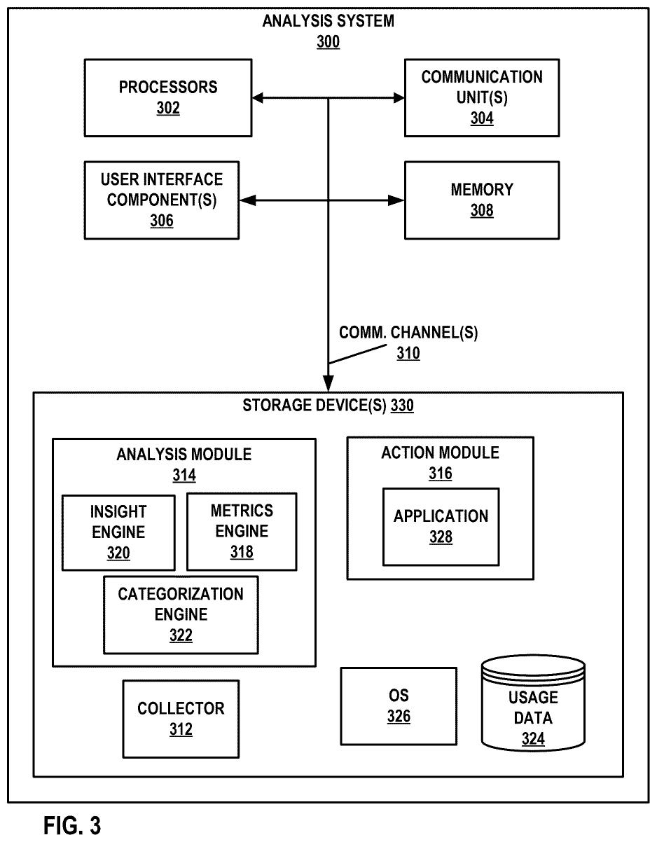

FIG. 3 is an example computing system 300, in accordance with one or more aspects of this disclosure. Analysis system 300 may be similar to computing system 110 as illustrated in FIG. 1. For example, analysis system 300 may obtain usage data from platforms, such as platforms 130 of distributed network 100 as illustrated in FIG. 1, and generate instructions.

Analysis system 300 includes one or more of processors 302 that include one or more types of processors and processing circuitry, such as single-core processors, multi-core processors, Field-Programmable Gate Arrays (FPGAs), and other types of processors and processing circuitry. Processors 302 may execute the instructions of software components of analysis system 300 and process information. For example, processors 302 may execute the instructions of a software component to process information obtained via communication units 304.

Analysis system 300 includes one or more of communication units 304, which may be components of analysis system 300 that enable communication with other computing devices. Communication units 304 may include one or more types of communications components, such as network interface cards (NICs), wireless radios, wireless modems, optical interfaces, transceivers and other types of communication components that enable communication via one or more protocols such as WIFI, BLUETOOTH, SONET, and/or other protocols. For example, communication units 304 may receive data regarding the usage of network resources associated with platforms 130.

Analysis system 300 includes one or more of user interface components 306 (hereinafter “UIC 306”) which may include one or more input and output devices. UIC 306 may include input components such as touchscreens, keyboards, mice, microphones, cameras, and/or other input components. UIC 306 may include output devices, such as displays, speakers, haptic engines, and/or other types of output devices. UIC 306 may enable a user to interact with analysis system 300.

Analysis system 300 includes memory 308, which may be volatile storage of analysis system 300. Memory 308 may include one or more types of volatile storage, such as random access memory (RAM), electrically erasable read-only memory (EEPROM), and/or other types of memory. Memory 308 may store information that includes the instructions of software components during execution by processors 302.

Analysis system 300 includes one or more of communication channels 310 (illustrated as “COMM. CHANNEL(S) 310” in FIG. 3) that connect one or more components of analysis system 300. Communication channels 308 may include one or more of hardware interconnects, software interconnects, and/or other types of components connecting the components of analysis system 300. For example, communication channels 308 may connect storage devices 310 with processors 302.

Analysis system 300 includes one or more storage devices 330 that store information. Storage devices 330 may include one or more devices capable of storing data that include hard disk drives, solid state drive, NVM Express (NVMe), magnetic tape drives, and/or other types of storage. Storage device 330 may store data, such as usage data 324, and instructions for one or more software components, such as OS 326.

Storage devices 330 include OS 326, which may be an operating system of analysis system 300. OS 326 may provide an execution environment for other software components of analysis system 300 and facilitate the maintaining of date in storage devices. For example, OS 326 may facilitate the execution of the instructions of collector 312 by processors 302.

Storage devices 330 include collector 312, which may be a software component of analysis system 300 that is similar collector 112 as illustrated in FIG. 1 and/or collector 212 as illustrated in FIG. 2. Collector 312 may obtain usage data from platforms 130 via communication units 304 and store the usage data in usage data 324. For example, collector 312 obtain usage data from platform 130A regarding the usage of compute resource by a particular organizational unit and store the usage data in usage data 324.

Storage devices 330 include usage data 342, which may be a data repository, data store, data lake, and/or other type of data storage. Usage data 324 may include data obtained by collector 312 from one or more of platforms 130, such as information regarding resource usage (e.g., compute, storage, etc.). For example, analysis system 300 may maintain information in usage data 324 for use by other components of analysis system 300, such as analysis module 314.

Storage devices 330 include analysis module 314, which may be a software component of analysis system 300 that is similar to analysis module 214 as illustrated in FIG. 1 and/or analysis module 214 as illustrated in FIG. 2. Analysis module 314 may analyze usage data 324 to generate metrics according to one or more categories. Analysis system module 314 may use the metrics to generate actionable insights based on the metrics for one or more organizational units.

Analysis module 314 includes metrics engine 318, which may be a software component of analysis system 300 that generates metrics based on usage data obtained by collector 312 and may be similar to metrics processing engine 222 as illustrated in FIG. 2. Metrics engine 318 may generate one metrics for one or more categories that includes cost, capacity, access, and operations. For example, metrics engine 318 may generate metrics regarding the usage of compute resources by individual organizational units.

Analysis module 314 includes categorization engine 322, which may be a software component of analysis system 300 that categorizes metrics into one or more categories and may be similar to categorization engine 224 as illustrated in FIG. 2. Categorization engine 322 may categorize a given metric into multiple categories, such as when a metric is applicable to the multiple categories. For example, categorization engine 322 may categorize a metric regarding the usage of compute resources into both the cost category (e.g., for use in determining organizational financial costs associated with the usage of the usage of the compute resources) and the capacity category (e.g., to determine whether an organizational unit is assigned sufficient compute resources). One or more components of analysis system 300, such as insight engine 320 may use the metrics categorized by categorization engine 322.

Analysis module 314 includes insight engine 320, which may be a software component of analysis system 300 that generates actionable insights that are insights into the operation and experience of using platforms 130 and may be similar insight processing engine 234 as illustrated in FIG. 2. Insight engine 320 may generate actionable insights for one or more of the categories using the metrics categorized by categorization engine 322. In an example, insight engine 320 processes the categorized metrics to generate an actionable insight for the cost category of the costs incurred by an organizational unit and provides the actionable insight to action module 316.

Storage devices 330 include action module 316, which may be a software component of analysis system 300 that generates instructions configured to cause other computing systems to perform actions. Action module 316 may generate the instructions based on actionable insights for one or more of the categories. In an example, action module 316 generates instructions configured to cause a computing system to generate an invoice for organizational financial costs associated with compute usage by an organizational unit. Action module 316 causes communication units 304 to provide the instructions to a computing system to generate the invoice.

In some examples, analysis system 300 may generate user interfaces that include information, such as the actionable insights and metrics. Analysis system 300 may use application 328, which may be a software component of analysis system 300. Application 328 may be a standalone application, an executable, a microservice, nano application, and/or other type of software component that generates user interfaces. In an example, application 328 generates a user interface that includes a graph of organizational financial costs by type of resources used. Application 328 may output the user interfaces for display via UIC 306 and/or provide data regarding the user interfaces to another computing device via communication units 304 for display.

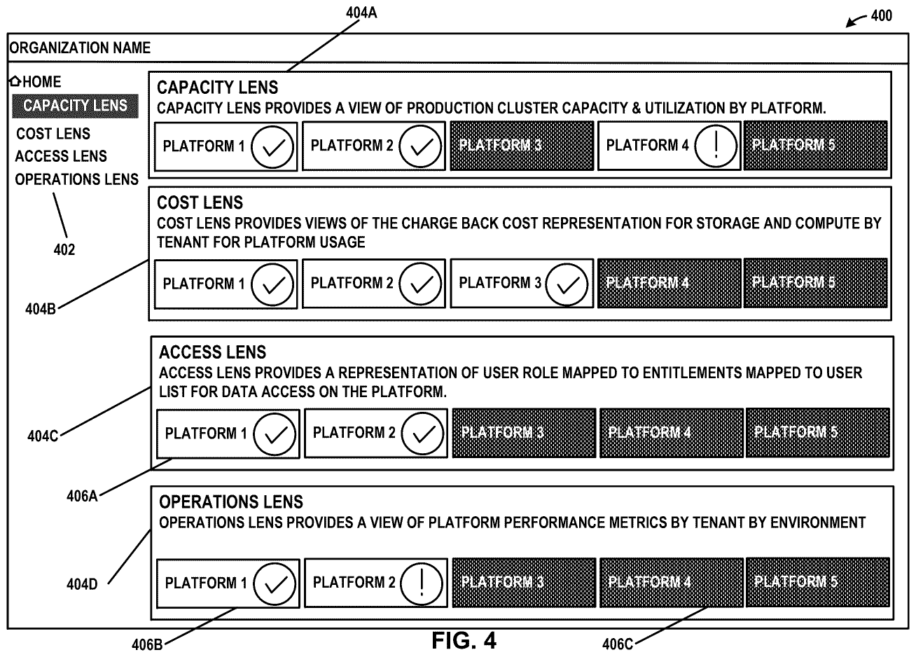

FIG. 4 is an example user interface 400 for a unified control plane, in accordance with one or more aspects of this disclosure. For the purposes of clarity, FIG. 4 is described in the context of FIG. 2. For example, application 238 may generate user interface 400 (hereinafter “UI 400”).

Application 238 generates UI 400 as including menu 402, which may be a menu of one or more categories that may be viewed. In the example of FIG. 4, menu 402 includes “COST LENS” (corresponding to cost category 226), “CAPACITY LENS” (corresponding to capacity category 228), “ACCESS LENS” (corresponding to access category 230), and “OPERATIONS LENS” (corresponding to operations category 232). Application 238 may enable a user to select any of the tabs in menu 402 to navigate to a different category.

Application 238 generates UI 400 as including lens tabs 404A-404D (hereinafter “lens tabs 404”). Lens tabs 404 may be visual elements of UI 400 that correspond to different categories and include a description of the category. In the example of FIG. 4, lens tab 404A includes the title “CAPACITY LENS” and a description of the capacity lens (“CAPACITY LENS PROVIDES A VIEW OF PRODUCTION CLUSTER CAPACITY & UTILIZATION BY PLATFORM”), lens tab 404B includes the title “COST LENS” and a description of the cost lens (“COST LENS PROVIDES VIEWS OF THE CHARGE BACK COST REPRESENTATION FOR STORAGE AND COMPUTE BY TENANT FOR PLATFORM USAGE”), lens tab 404C includes the title “ACCESS LENS” and a description of the access lens (“ACCESS LENS PROVIDES A REPRESENTATION OF USER ROLE MAPPED TO ENTITLEMENTS MAPPED TO USER LIST FOR DATA ACCESS ON THE PLATFORM”), and lens tab 404D includes the title “OPERATIONS LENS” and a description of the operations lens (“OPERATIONS LENS PROVIDES A VIEW OF PLATFORM PERFORMANCE METRICS BY TENANT BY ENVIRONMENT”). Each of the lenses included in lens tabs 404 may correspond to category illustrated in FIG. 2 (e.g., cost lens to cost category 226, capacity lens to capacity category 228, etc.).

Application 238 generates GUI 400 as including platform status indicators 406A-406C (hereinafter “platform status indicators 406”), which may be visual elements that correspond to the status of platforms. Application 238 may generate platform status indicators 406 based on metrics and actionable insights. For example, application 238 may generate a platform status indicator as greyed out to indicate that a corresponding platform is disabled or that no metrics have been received from the platform. In the example of FIG. 4, application 238 generates platform status indicator 406A for access lens tab 404C and platform status indicator 406B for operations lens tab 404D as indicating that “PLATFORM 1” is healthy with respect to the access category and the operations category. Application 238 may also generate platform status indicator 406C for operations lens tab 404D as indicating that “PLATFORM 4” is disabled or has no available metrics for the operations category.

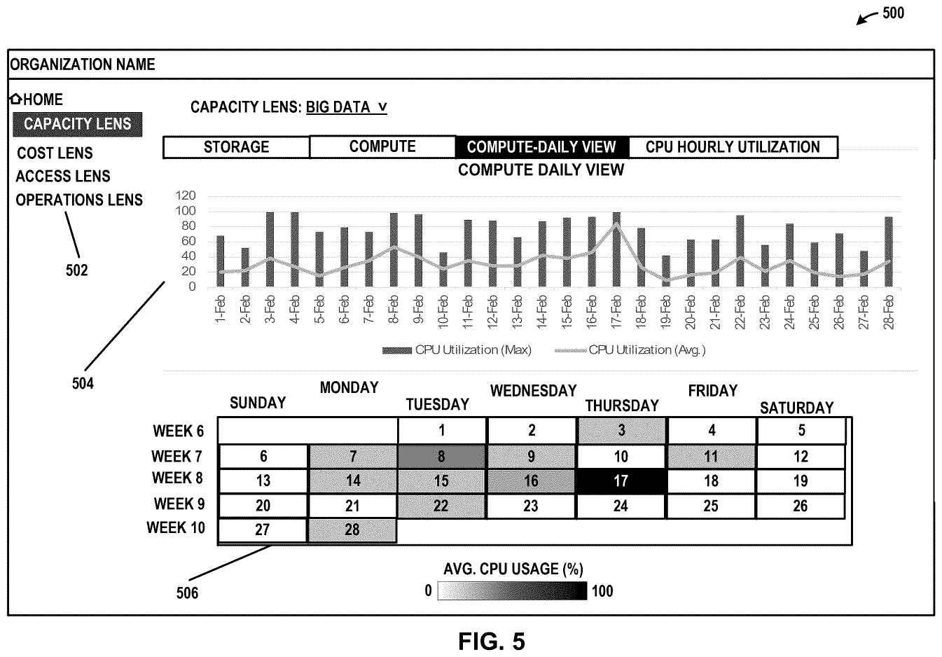

FIG. 5 is an example user interface 500 for a capacity category of a unified control plane, in accordance with one or more aspects of this disclosure. For the purposes of clarity, FIG. 5 is described in the context of FIG. 2. For example, application 238 may generate user interface 500 (hereinafter “UI 500”).

Application 238 may generate UI 500 as including menu 502, which may include one or more visual indicators that correspond to categories that may be viewed and a visual indication of a currently selected category. In the example of FIG. 5, of application 238 generates menu 502 as including “CAPACITY LENS” selected by a user.

Application 238 may generate UI 500 as including one or more sub-tabs or visual elements that correspond to metrics or actionable insights related to a selected category. In the example of FIG. 5, application 238 generates UI 500 as including the sub-tabs “STORAGE”, “COMPUTE”, “COMPUTE-DAILY VIEW”, and “CPU HOURLY UTILIZATION”. Application 238 may generate UI 500 as including each of sub-tabs corresponding to various metrics and actionable insights within the capacity category. For example, application 238 may generate UI 500 as including graphs visually illustrating CPU usage (e.g., compute usage) across a predetermined period of time.

In the example of FIG. 5, application 238 generates UI 500 as including usage graph 504 and usage matrix 506, which may include visual elements that illustrate compute usage over a defined period. For instance, in the example of FIG. 5, application 238 generates usage graph 504 as a graph that visually illustrates daily maximum and average compute usage from February 1 through February 28. Additionally, application 238 generates usage matrix as visually displaying the same average compute usage information as usage graph 504 but in a matrix format, with color shading denoting the average compute usage for a given day. In various other examples, application 238 may generate usage graph 504 and/or usage matrix 506 over a different time period, e.g., one week, one month, one quarter, one year, etc. That is, the time periods illustrated in FIG. 5 are one of many examples.

Application 238 may output UI 500 to a user, such as an administrator, for the administrator to understand the usage and user experience associated with using platforms of a distributed network (e.g., platforms 130 of distributed network 100 as illustrated in FIG. 1). Application 238 may output UI 500 to an administrator for the administrator to understand patterns of compute usage and whether there is sufficient compute resources available for an organizational unit. For example, application 238 may output UI 500 to enable an administrator to understand that, on particular days, a given organizational unit uses a majority of the compute resources allocated to the organizational unit.

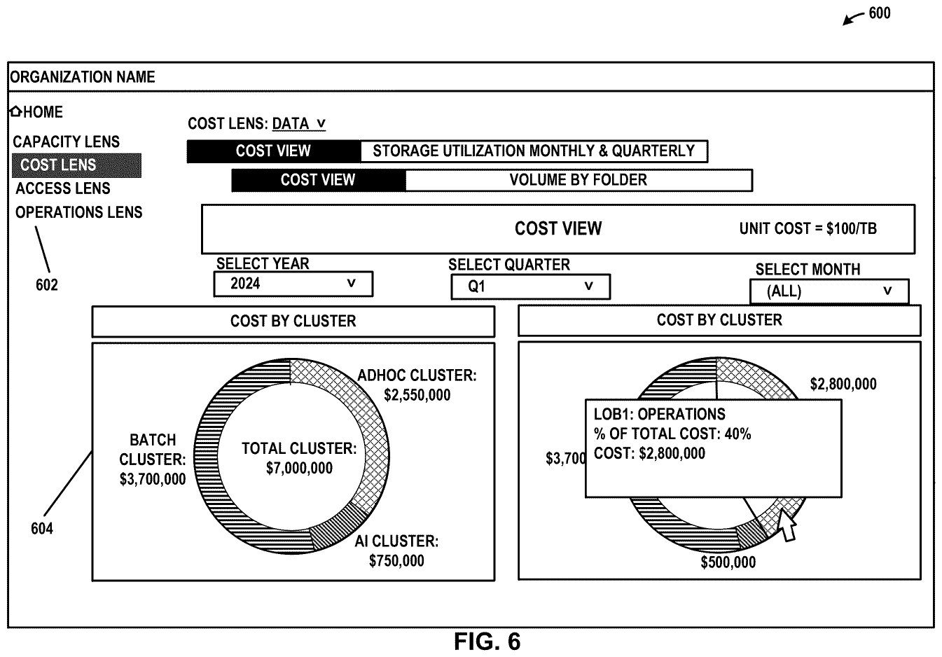

FIG. 6 is an example user interface 600 for a cost category of a unified control plane, in accordance with one or more aspects of this disclosure. For the purposes of clarity, FIG. 6 is described in the context of FIG. 2. For example, application 238 may generate user interface 600 (hereinafter “UI 600”).

Application 238 may generate UI 600 as including menu 602, which may include one or more visual indicators that correspond to categories that may be viewed and a visual indication of a currently selected category. In the example of FIG. 6, of application 238 generates menu 602 as including “COST LENS” selected by a user. Application 238 may generate UI 600 as including visual elements that visually display metrics and/or actionable insights included in cost category 226.

Application 238 may generate UI 600 as including one or more sub-tabs or visual elements that correspond to metrics or actionable insights related to a selected category. In the example of FIG. 6, application 238 generates UI 600 as including the sub-tabs “COST VIEW” and “STORAGE UTILIZATION MONTHLY & QUARTERLY”. In addition, application 238 generates UI 600 as including sub-tabs under the “COST VIEW” that includes “COST VIEW” and “VOLUME BY FOLDER”. Application 238 may generate UI 600 as including each of sub-tabs corresponding to various metrics and actionable insights within cost category 226. For example, application 238 may generate UI 600 as including graphs visually illustrating cost by cluster usage and organizational unit.

In the example of FIG. 6, application 238 generates UI 600 as including cost graphs 604, which may be visual elements of UI 600. Application 238 may generate cost graphs 604 based on metrics and/or actionable insights generated by analysis module 214. For example, application 238 may generate UI 600 as including a first graph visually illustrating costs associated clusters of a distributed network and a second graph visually illustrating costs associated with individual organizational units as portions of an entire cost.

Application 238 may output UI 600 to a user, such as an administrator, for the administrator to understand the usage and user experience associated with using platforms of a distributed network (e.g., platforms 130 of distributed network 100 as illustrated in FIG. 1). Application 238 may output UI 600 to an administrator for the administrator to understand costs incurred by organizational units of distributed network 100. For example, application 238 may output UI 600 to enable an administrator to understand that a particular organizational unit incurs a significant percentage of costs.

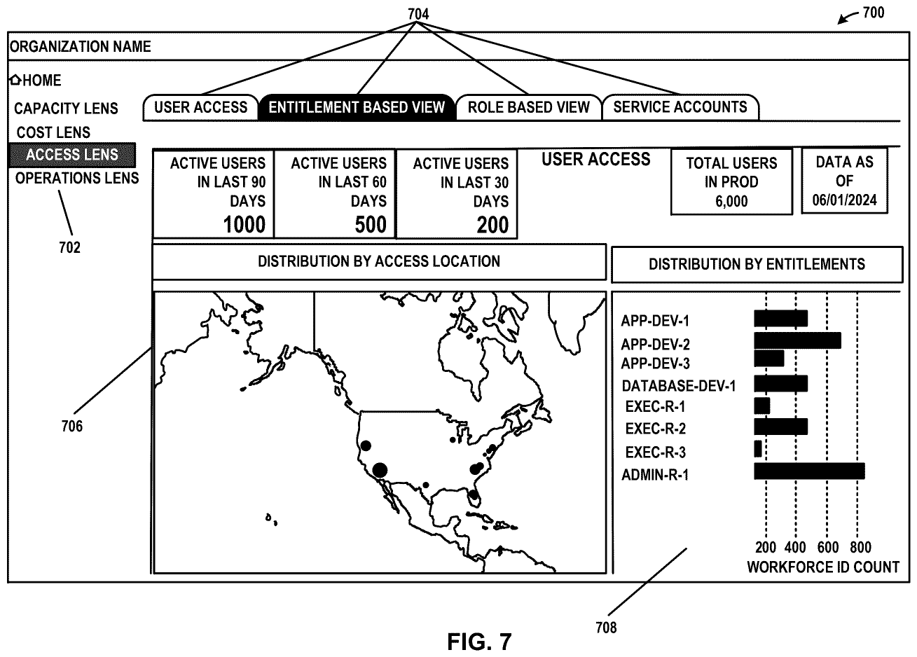

FIG. 7 is an example user interface 700 for an access category of a unified control plane, in accordance with one or more aspects of this disclosure. For the purposes of clarity, FIG. 7 is described in the context of FIG. 2. For example, application 238 may generate user interface 700 (hereinafter “UI 700”).

Application 238 may generate UI 700 as including menu 702, which may include one or more visual indicators that correspond to categories that may be viewed and a visual indication of a currently selected category. In the example of FIG. 7, of application 238 generates menu 702 as including “ACCESS LENS” selected by a user. Application 238 may generate UI 700 as including visual elements that visually display metrics and/or actionable insights included in access category 230.

Application 238 may generate UI 700 as including one or more sub-tabs or visual elements that correspond to metrics or actionable insights related to a selected category. In the example of FIG. 7, application 238 generates UI 700 as including the sub-tabs “USER ACCESS”, “ENTITLEMENT BASED VIEW”, “ROLE BASED VIEW”, and “SERVICE ACCOUNTS”. In addition, application 238 generates UI 700 as including sub-tabs under the “ENTITLEMENT BASED VIEW” that include “ACTIVE USERS IN THE LAST 90 DAYS”, “ACTIVE USERS IN THE LAST 60 DAYS”, “ACTIVE USERS IN THE LAST 30 DAYS”, “USER ACCESS”, and “TOTAL USERS IN PROD”. Application 238 may generate UI 700 as including each of sub-tabs corresponding to various metrics and actionable insights within cost category 226. For example, application 238 may generate UI 700 as including a map of North America visually overlayed with user login locations in addition to a graph displaying entitlement distribution by user role.

In the example of FIG. 7, application 238 generates UI 700 as including entitlement map 706 and entitlement graph 708, which may be visual elements that visually display metrics and/or actionable insights included in access category 230. Entitlement map 706 may be a visual element that includes a map of a region (e.g., portions of North America, South America, and Asia as illustrated in FIG. 7) visually overlayed with “hotspots” representative of user access locations and the number of users accessing at a given location (e.g., the circle overlaying Southern California being larger than the circle overlaying the Chicago metropolitan area). Application 238 may generate entitlement map 706 as visually indicating a number of users accessing platforms from locations that include metropolitan areas, geographic regions, and/or organization-defined regions.

Application 238 may generate entitlement graph 708 as including visual indications of the number of users by role (e.g., an identifier indicative of assigned user access entitlements based on the position of each user). In the example of FIG. 7, application 238 generates entitlement graph 708 as including eight user roles and associated number of users assigned to each of those roles. Application 238 may generate entitlement graph 708 based on metrics generated for access category 230.

Application 238 may output UI 700 to a user, such as an administrator, for the administrator to understand user access entitlements associated with platforms of a distributed network (e.g., platforms 130 of distributed network 100 as illustrated in FIG. 1). Application 238 may output UI 700 to an administrator for the administrator to understand where users are accessing platforms 130 from and how many users are associated with different roles. For example, application 238 may output UI 700 to enable an administrator to understand user access entitlements from a geographic distribution perspective.

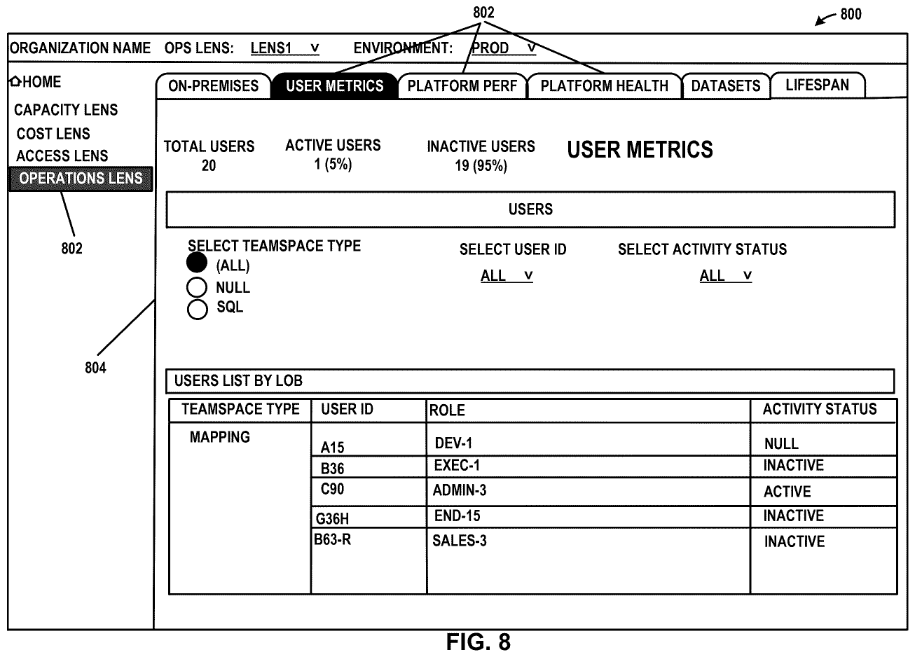

FIG. 8 is an example user interface 800 or an operations category of a unified control plane, in accordance with one or more aspects of this disclosure. For the purposes of clarity, FIG. 8 is described in the context of FIG. 2. For example, application 238 may generate user interface 800 (hereinafter “UI 800”).

Application 238 may generate UI 800 as including menu 802, which may include one or more visual indicators that correspond to categories that may be viewed and a visual indication of a currently selected category. In the example of FIG. 8, application 238 generates menu 802 as including “OPERATIONS LENS” selected by a user. Application 238 may generate UI 800 as including visual elements that visually display metrics and/or actionable insights included in access category 230.

Application 238 may generate UI 800 as including one or more sub-tabs or visual elements that correspond to metrics or actionable insights related to a selected category. In the example of FIG. 8, application 238 generates UI 800 as including the sub-tabs “ON-PREMISES”, “USER METRICS”, “PLATFORM PERF”, “PLATFORM HEALTH”, “DATASETS”, and “LIFESPAN”. Application 238 may generate UI 800 as including each of sub-tabs corresponding to various metrics and actionable insights within operations category 232. For example, application 238 may generate UI 800 as including lists of users associated with a given organizational unit or line of business.

In the example of FIG. 8, application 238 generates UI 800 as including user metric element 804, which may be a visual element of UI 800 that includes visual indications of various metrics associated with users of a distributed network (e.g., distributed network 100 as illustrated in FIG. 1). Application 238 may generate user metrics element 804 using metrics and/or actionable insights generated by analysis module 214. For example, application 238 may use metrics regarding users associated with a particular line of business to generate user metric element 804 as including a table of user identifiers for an organizational unit and associated roles and activity status.

Application 238 may output UI 800 to a user, such as an administrator, for the administrator to understand various metrics associated with the operation of platforms of distributed network 100 (e.g., platforms 130 as illustrated in FIG. 1) and users of distributed network 100. Application 238 may output UI 800 to an administrator for the administrator to understand which users are assigned to particular lines of business and other information regarding the operation of distributed network 100. For example, application 238 may output UI 800 to enable an administrator to understand the status of organizational units and the health of platforms 130.

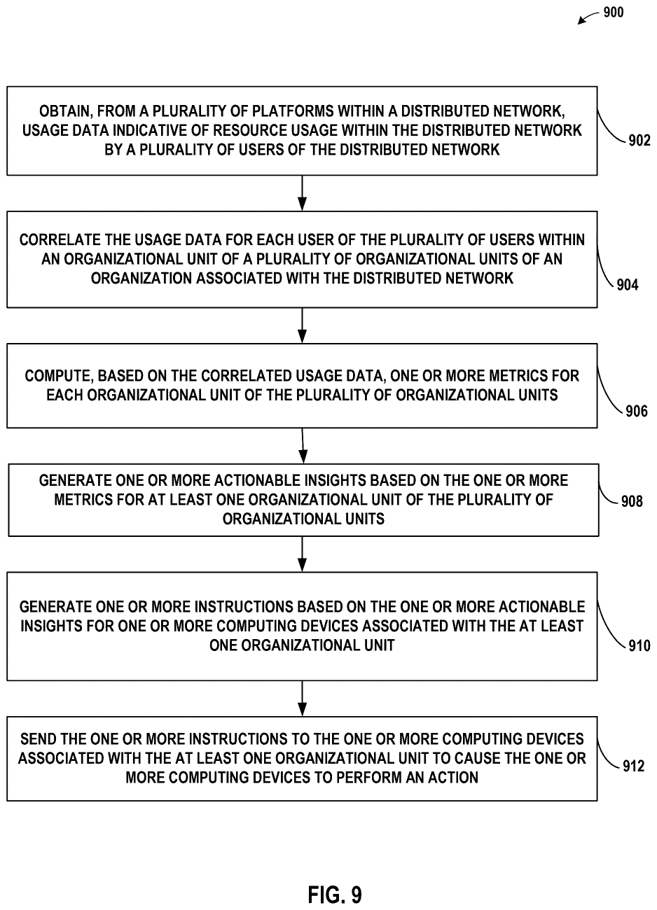

FIG. 9 is a flow chart illustrating an example operation 900 of providing a unified control plane across data platforms, in accordance with one or more aspects of this disclosure. For the purposes of clarity, FIG. 9 is described in the context of FIG. 1. For example, computing system 110 may perform one or more of the steps of operation 900.

Computing system 110 obtains, from a plurality of platforms within a distributed network (e.g., platforms 130 of distributed network 100), usage data indicative of resource usage within distributed network 100 by a plurality of users of distributed network 100, such as users 125 (902). Computing system 110 may obtain usage data, such as usage data 144, from platforms 130 that are included in private and/or public clouds, such as public cloud 104 and/or enterprise cloud 106. Computing system 110 may obtain usage data 142 that includes data in multiple formats and regarding different aspects of the usage of network resources, the performance of platforms 130, user access to platforms 130, and/or other information.

Computing system 110 correlates the usage data for each user of users 125 within an organizational unit of a plurality of organizational units of an organization associated with distributed network 100, such as organizational units 120 (904). Computing system 110 may correlate usage data for organizational units that are associated with lines of business of an organization (e.g., sales, wealth management, etc.) that each include users of users 125 that are within the organizational unit. Computing system 110 may correlate the usage data with organizational units 120 by aggregating usage data associated with user identifiers to the organizational units that includes the user identifiers. In an example, computing system 110 obtains usage data associated with user identifiers of users 125A-125M. Computing system 110 aggregates the usage data to correlate the usage data with organizational unit 120A.

Computing system 110 computes, based on the correlated usage data, one or more metrics for each organizational of organizational units 120 (906). Computing system 110 may compute metrics for one or more categories that include a cost category, a capacity category, an access category, and/or an operations category. Computing system 110 may compute metrics that include metrics regarding user access entitlements, total resource consumption, platform performance, and/or other metrics.

Computing system 110 generates one or more actionable insights based on the one or more metrics for at least one of organizational units 120 (908). Computing system 110 may generate actionable insights that are insights into the performance and the usage of platforms 130. For example, computing system 110 may generate actionable insights that are insights into the management and experience of using platforms 130 by users of the platforms. Computing system 110 may generate actionable insights for one or more of the categories and that may be relevant to multiple categories. In an example, computing system 110 generates an actionable insight for the cost category that is an insight into the costs incurred by organizational unit 120A due to the usage of network resources.

Computing system 110 generates one or more instructions, such as instructions 144, based on the actionable insights for one or more computing devices, such as org systems 126, associated with the at least one organizational unit (910). Computing system 110 generates instructions that are configured to cause org systems 126 to perform an action, such as generating an invoice, requesting the verification of user access entitlements, generating a support ticket, modifying allocations of network resources, and/or other actions. For example, computing system 110 may generate instructions 144 as configured to cause to cause org system 126A to generate an invoice for the cost of network resources used by organizational unit 120A. In some examples, org systems 126 may operate independently of organizational units 120.

Computing system 110 sends instructions 144 to one or more of org systems 126 to cause org systems 126 to perform the action (912). Org systems 126 may perform action in response to receiving instructions 144. In an example, org system 126A receives instructions 144 and generates an invoice for the cost of network resources consumed by organizational unit 120A.

Various examples have been described. These and other examples are within the scope of the following claims.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each depict at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the illustrations and/or may include additional devices and/or components not shown in the illustrations.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses. Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method, comprising:
obtaining, by a computing system and from a plurality of platforms within a distributed network, usage data indicative of resource usage within the distributed network by a plurality of users of the distributed network;
correlating, by the computing system, the usage data for each user of the plurality of users with an organizational unit of a plurality of organizational units of an organization associated with the distributed network;
computing, by the computing system and based on the correlated usage data, one or more metrics for each organizational unit of the plurality of organizational units;
generating, by the computing system, one or more actionable insights based on the one or more metrics for at least one organizational unit of the plurality of organizational units;
generating, by the computing system, one or more instructions based on the one or more actionable insights for one or more computing devices associated with the at least one organizational unit, wherein the instructions are configured to cause the one or more computing devices to perform an action; and
sending, by the computing system, the one or more instructions to the one or more computing devices associated with the at least one organizational unit to cause the one or more computing devices to perform the action.

2. The method of claim 1, wherein the one or more actionable insights include actionable insights corresponding to a cost category that is representative of financial costs related to the resource usage within the distributed network, and
wherein generating the one or more actionable insights corresponding to the cost category includes determining organizational financial costs for the at least one organizational unit of the plurality of organizational units based on the one or more metrics corresponding to the cost category for the at least one organizational unit.

3. The method of claim 2, wherein computing the one or more metrics corresponding to the cost category includes:
aggregating the resource usage by each user having a user identifier associated with the at least one organizational unit into an organizational resource usage for the at least one organizational unit, wherein the resource usage by each user includes at least one of:
storage usage associated with the user identifier associated with the at least one organizational unit, or
compute usage associated with the user identifier associated with the at least one organizational unit.

4. The method of claim 2, wherein generating the one or more instructions includes generating the one or more instructions to cause the one or more computing devices to generate an invoice for the at least one organizational unit based on the organizational financial costs for the at least one organizational unit.

5. The method of claim 2,
wherein generating the one or more actionable insights corresponding to the cost category includes forecasting organizational financial costs for the at least one organizational unit of the plurality of organizational units based on predicted organizational resource usage for a subsequent time period, and
wherein generating the one or more instructions includes generating the one or more instructions to cause the one or more computing devices to generate a report for the at least one organizational unit based on the forecasted organizational financial costs for the at least one organizational unit.

6. The method of claim 1, wherein the one or more actionable insights include actionable insights corresponding to a capacity category that is representative of capacity of network resources within the distributed network,
wherein generating the one or more actionable insights corresponding to the capacity category includes determining organizational resource capacity for the at least one organizational unit of the plurality of organizational units based on the one or more metrics corresponding to the capacity category for the at least one organizational unit, and
wherein generating the one or more instructions includes generating the one or more instructions to cause the one or more computing devices to modify an allocation of network resources within the distributed network for the at least one organizational unit based on the organizational resource capacity for the at least one organizational unit.

7. The method of claim 1, wherein the one or more actionable insights include actionable insights corresponding to an access category that is representative of access entitlements to the plurality of platforms for each user of the plurality of users,
wherein generating the one or more actionable insights corresponding to the access category includes determining organizational entitlement mapping for the at least one organizational unit of the plurality of organizational units based on the one or more metrics corresponding to the access category for the at least one organizational unit, and
wherein generating the one or more instructions includes generating the one or more instructions to cause the one or more computing devices to certify the access entitlements of at least one user of the plurality of users having a user identifier associated with the at least one organizational unit based on the organizational entitlement mapping for the at least one organizational unit.

8. The method of claim 7, wherein the one or more instructions are first instructions, the method further comprising:
receiving, by the computing system, an indication of an incorrect access entitlement for the at least one user having the user identifier associated with the at least one organizational unit; and
generating, by the computing system, second instructions to cause the one or more computing systems to modify an access entitlement for the at least one user based on the indication of the incorrect access entitlement.

9. The method of claim 7, further comprising:
identifying, by the computing system and based on the actionable insights corresponding to the access category, at least one incorrect access entitlement for the at least one user having the user identifier associated with the at least one organizational unit, wherein identifying the at least one incorrect access entitlement includes comparing the access entitlements for the at least one user to a corresponding role of the at least one user, wherein the corresponding role includes a predetermined access entitlement for the at least one user.

10. The method of claim 1, wherein the one or more actionable insights include actionable insights corresponding to an operations category that is representative of operational performance of the plurality of platforms,
wherein generating the one or more actionable insights corresponding to the operations category includes determining organizational performance for the at least one organizational unit of the plurality of organizational units based on the one or more metrics corresponding to the operations category for the at least one organizational unit, and
wherein generating the one or more instructions includes generating the one or more instructions to cause the one or more computing devices to modify a configuration of at least one platform of the plurality of platforms for the at least one organizational unit based on the organizational performance for the at least one organizational unit.

11. The method of claim 1, wherein the plurality of platforms of the distributed network are hosted by at least one of:
a public cloud, or
a private cloud.

12. The method of claim 1, wherein obtaining the usage data includes:
extracting the usage data on a per-user level from the plurality of platforms.

13. A computing system, comprising:
memory; and
one or more programmable processors in communication with the memory, and configured to:
obtain, from a plurality of platforms within a distributed network, usage data indicative of resource usage within the distributed network by a plurality of users of the distributed network;
correlate the usage data for each user of the plurality of users with an organizational unit of a plurality of organizational units of an organization associated with the distributed network;
compute, based on the correlated usage data, one or more metrics for each organizational unit of the plurality of organizational units;
generate one or more actionable insights based on the one or more metrics for at least one organizational unit of the plurality of organizational units;
generate one or more instructions based on the one or more actionable insights for one or more computing devices associated with the at least one organizational unit, wherein the instructions are configured to cause the one or more computing devices to perform an action; and
send the one or more instructions to the one or more computing devices associated with the at least one organizational unit to cause the one or more computing devices to perform the action.

14. The computing system of claim 13, wherein the one or more actionable insights include actionable insights corresponding to a cost category that is representative of financial costs related to the resource usage within the distributed network, and
wherein to generate the one or more actionable insights corresponding to the cost category, the one or more programmable processors are further configured to determine organizational financial costs for the at least one organizational unit of the plurality of organizational units based on the one or more metrics corresponding to the cost category for the at least one organizational unit.

15. The computing system of claim 14, wherein to compute the one or more metrics corresponding to the cost category, the one or more programmable processors are further configured to:
aggregate the resource usage by each user having a user identifier associated with the at least one organizational unit into an organizational resource usage for the at least one organizational unit, wherein the resource usage by each user includes at least one of:
storage usage associated with the user identifier associated with the at least one organizational unit, or
compute usage associated with the user identifier associated with the at least one organizational unit.

16. The computing system of claim 14, wherein to generate the one or more instructions, the one or more programmable processors are further configured to generate the one or more instructions to cause the one or more computing devices to generate an invoice for the at least one organizational unit based on the organizational financial costs for the at least one organizational unit.

17. The computing system of claim 14,
wherein to generate the one or more the one or more actionable insights corresponding to the cost category, the one or more programmable processors are further configured to forecast organizational financial costs for the at least one organizational unit of the plurality of organizational units based on predicted organizational resource usage for a subsequent time period, and
wherein to generate the one or more instructions, the one or more programmable processors are further configured to generate the one or more instructions to cause the one or more computing devices to generate a report for the at least one organizational unit based on the forecasted organizational financial costs for the at least one organizational unit.

18. The computing system of claim 13, wherein the one or more actionable insights include actionable insights corresponding to a capacity category that is representative of capacity of network resources within the distributed network,
wherein to generate the one or more actionable insights corresponding to the capacity category, the one or more programable processors are further configured to determine organizational resource capacity for the at least one organizational unit of the plurality of organizational units based on the one or more metrics corresponding to the capacity category for the at least one organizational unit, and
wherein to generate the one or more instructions, the one or more programmable processors are further configured to generate the one or more instructions to cause the one or more computing devices to modify an allocation of network resources within the distributed network for the at least one organizational unit based on the organizational resource capacity for the at least one organizational unit.

19. The computing system of claim 13, wherein the one or more actionable insights include actionable insights corresponding to an access category that is representative of access entitlements to the plurality of platforms for each user of the plurality of users,
wherein to generate the one or more actionable insights corresponding to the access category, the one or more programmable processors are further configured to determine organizational entitlement mapping for the at least one organizational unit of the plurality of organizational units based on the one or more metrics corresponding to the access category for the at least one organizational unit, and
wherein to generate the one or more instructions, the one or more programmable processors are further configured to generate the one or more instructions to cause the one or more computing devices to certify the access entitlements of at least one user of the plurality of users having a user identifier associated with the at least one organizational unit based on the organizational entitlement mapping for the at least one organizational unit.

20. The computing system of claim 19, wherein the one or more instructions are first instructions, and wherein the one or more programmable processors are further configured to:
receive an indication of an incorrect access entitlement for the at least one user having the user identifier associated with the at least one organizational unit; and
generate second instructions to cause the one or more computing systems to modify an access entitlement for the at least one user based on the indication of the incorrect access entitlement.

21. The computing system of claim 19, wherein the one or more programmable processors are further configured to:
identify, based on the actionable insights corresponding to the access category, at least one incorrect access entitlement for the at least one user having the user identifier associated with the at least one organizational unit, wherein to identify the at least one incorrect access entitlement the one or more programmable processors are further configured to compare the access entitlements for the at least one user to a corresponding role of the at least one user, wherein the corresponding role includes a predetermined access entitlement for the at least one user.

22. The computing system of claim 13, wherein the one or more actionable insights include actionable insights corresponding to an operations category that is representative of operational performance of the plurality of platforms,
wherein to generate the one or more actionable insights corresponding to the operations category the one or more programmable processors are further configured to determine organizational performance for the at least one organizational unit of the plurality of organizational units based on the one or more metrics corresponding to the operations category for the at least one organizational unit, and
wherein to generate the one or more instructions, the one or more programmable processors are further configured to generate the one or more instructions to cause the one or more computing devices to modify a configuration of at least one platform of the plurality of platforms for the at least one organizational unit based on the organizational performance for the at least one organizational unit.

23. Non-transitory computer-readable media including instructions that, when executed, cause processing circuitry to:
obtain, from a plurality of platforms within a distributed network, usage data indicative of resource usage within the distributed network by a plurality of users of the distributed network;
correlate the usage data for each user of the plurality of users with an organizational unit of a plurality of organizational units of an organization associated with the distributed network;
compute, based on the correlated usage data, one or more metrics for each organizational unit of the plurality of organizational units;
generate one or more actionable insights based on the one or more metrics for at least one organizational unit of the plurality of organizational units;
generate one or more instructions based on the one or more actionable insights for one or more computing devices associated with the at least one organizational unit, wherein the instructions are configured to cause the one or more computing devices to perform an action; and
send the one or more instructions to the one or more computing devices associated with the at least one organizational unit to cause the one or more computing devices to perform the action.
